(19) United States
(12) Patent Application Publication
(10) Pub. No.: US 2006/0268564 A1
(43) Pub. Date: Nov. 30, 2006

(54) LIGHTING OR SIGNALLING DEVICE WITH IMPROVED APPEARANCE FOR A MOTOR VEHICLE

(75) Inventor: Carlos Gomez Ruiz, 23600 Martos (ES)

Correspondence Address: MATTHEW R. JENKINS, ESQ., 2310 FAR HILLS BUILDING, DAYTON, OH, 45419, US

(73) Assignee: VALEO VISION, Bobigny (FR)

(21) Appl. No.: 11/420,231

(22) Filed: May 25, 2006

(30) Foreign Application Priority Data
May 27, 2005 (FR) 0505408

(51) Int. Cl. F21V 9/00

(52) U.S. Cl. 362/511; 362/554; 362/556

(57) ABSTRACT

A lighting or signalling device for a motor vehicle, comprising a light source and a light guide associated with the light source, the light rays issuing from the light source entering the light guide through an entry face and propagating in the light guide in order to emerge therefrom substantially parallel to a general direction of emission through an exit face. The guide comprises at least one internal intermediate wall or a lateral wall on which the light rays undergo at least one total reflection.

### BACKGROUND OF THE INVENTION

1. Field of the Invention

The present invention concerns lighting or signalling devices for motor vehicles.

2. Description of the Related Art

It is normal to connect together, in a single housing, several lighting or signalling functions, so as to simplify the electric wiring for these various functions in a motor vehicle. Each function comprises a light source, in general a reflector and possibly a lens, these various elements being arranged so as to provide a lighting or signalling beam whose geometric and photometric characteristics must be in accordance with various regulations.

Each function thus requires a minimum volume for its installation in a particular lighting or signalling device. However, the volume available for installing lighting or signalling devices is becoming smaller and smaller both at the front and at the rear of a modern motor vehicle. This is because the constraints of aerodynamics and the ideas of the designers result in shapes that are often very different from those resulting solely from technical considerations. As a result, in many cases, the space available for grouping together these functions in the same housing is insufficient and it is then necessary to distribute various functions in different housings, and hence a rise in the cost and an increase in the wiring and assembly time.

It has already been attempted to resolve this problem by using light guides. FIGS. 1 to 4 depict an example of a device using such a solution. It can be seen in FIG. 1 that a lamp 1 is intended to be mounted in a reflector 2 so as to concentrate the light rays issuing from the lamp 1 on the entry face 3 of optical fibres or groups of optical fibres 4. The reflector 2 is for example is of the elliptical type, the light source of the lamp 1 being placed in the vicinity of a first focus of the reflector 2, the faces 3 being available in the vicinity of the second focus of the reflector 2. The exit faces 5 of the optical fibres 4 are coupled to the entry faces 6 of the light guides 7.

The light guides 7, in the example shown, are configured so as to extend in a circular pattern, and are disposed for example so as to surround the front perimeter of a dipped beam headlight. The light guides 7 are for example in accordance with those described in the document DE-A-41 29 094. They comprise, as can be seen better in FIG. 2, a face 8 formed from a succession of prisms or serrations and an exit face 9, cylindrical or toric. The prisms or serrations on the face 8 return the light rays propagating in the light guide 7 towards the face 9 (FIG. 3), which supplies an exit beam from them, which can for example fulfil the function of a town lamp in a headlight.

Such a solution is particularly costly, since it requires a light source such as a halogen lamp, an elliptical reflector, a flexible cluster of optical fibres and a rigid light guide made from glass or plastics material, where one of the faces is machined so as to form prisms or serrations on it. In addition, it has as a drawback the fact that the light rays propagating in the guide are diverted by the serrations or prisms in an uncontrolled fashion, which causes numerous losses of light. Moreover, the periodic structure of the serrations or prisms is found in the emerging beam, so that the light guide has a greatly non-homogeneous appearance. Finally, this solution has the drawback of being very bulky so as to be able to house the light source, the reflector, the optical fibres and the light guides.

### SUMMARY OF THE INVENTION

The present invention is placed in this context and its purpose is to propose a lighting or signalling device that makes it possible easily to dispose a supplementary lighting and signalling function in a headlight, such a lighting or signalling device also having to be simple to assemble, reliable in its functioning and compact, the photometric performance complying with current regulations, such a device also having to be inexpensive.

The object of the invention is therefore a lighting or signalling device for a motor vehicle. In one aspect, one embodiment comprises a light source and a light guide associated with the light source, the light rays issuing from the light source entering the light guide through an entry face and propagating in the light guide in order to emerge therefrom substantially parallel to a general direction of emission by an exit face, the guide comprising at least one internal intermediate wall or a lateral wall on which the light rays undergo at least one total reflection.

According to one embodiment, the light source is associated with an optical system such that the light rays are emitted over 360° around the axis of this source, in an angle of approximately ±30° with respect to the horizontal plane perpendicular to an optical axis of the source.

According to other characteristics, other embodiments may include one or more of the following features:
the guide comprises a central section and at least one lateral section separated by at least one internal intermediate wall;
a direction of the light rays emitted by the light source passing through the central section is modified only by refractions on the entry and exit faces;
a direction of the light rays emitted by the light source passing through a lateral section is modified by at least one total reflection on at least one internal intermediate wall or a lateral wall;
a light source consists of at least one light emitting diode;
a light source associated with a light engine having an entry face, a rear reflection face, a front reflection face and an exit face, the light engine emitting radially outwards the rays that it receives from the light source;
a guide having a thickness that is small compared with its width;
a guide having an exit face of that has the form of a very elongate rectangle;
a guide having an exit face that extends over a portion of a circumference.

These and other objects and advantages of the invention will be apparent from the following description, the accompanying drawings and the appended claims.

### BRIEF DESCRIPTION OF THE DRAWINGS

Other aims, characteristics and advantages of the present invention will emerge clearly from the following description that will now be made of an example embodiment given non-limitingly with reference to the accompanying drawings, in which:

FIG. 1, already commented on, depicts a schematic view in perspective of an embodiment of the prior art;

FIG. 2 depicts a view to a larger scale of detail 11 in FIG. 1;

FIG. 3 depicts a view in longitudinal section of the light guide in FIG. 1 and 2;

FIG. 4 depicts a view in transverse section of the light guide in FIGS. 1 and 2;

FIG. 5 depicts a ¾ rear view in isometric perspective of half of the light guide according to the present invention;

FIG. 6 depicts a ¾ front view in isometric perspective of a first variant embodiment of a light guide according to the present invention;

FIG. 7 depicts a ¾ front view in isometric perspective of a second variant embodiment of a light guide according to the present invention;

FIG. 8 depicts a ¾ front view in isometric perspective of a third variant embodiment of a light guide according to the present invention;

FIG. 9 depicts the radiation diagram of a light emitting diode that can be used with light guide of one of FIGS. 5 to 8;

FIG. 10 depicts a variant light source that can be used with the light guide of one of FIGS. 5 to 8;, and

FIG. 11 depicts in exploded view a fourth variant embodiment of a light guide according to the present invention.

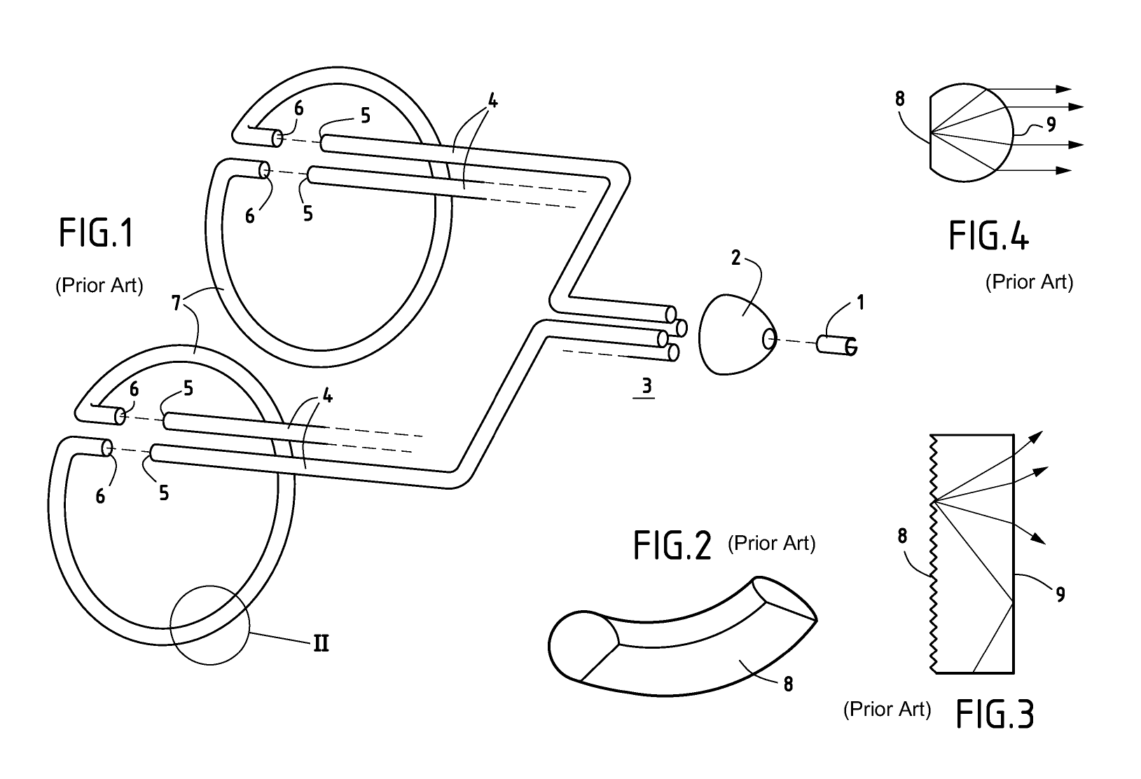

### DESCRIPTION OF THE PREFERRED EMBODIMENTS

By convention, in the present description, “front” means the direction in which the final light beam is emitted, and “rear” the opposite direction.

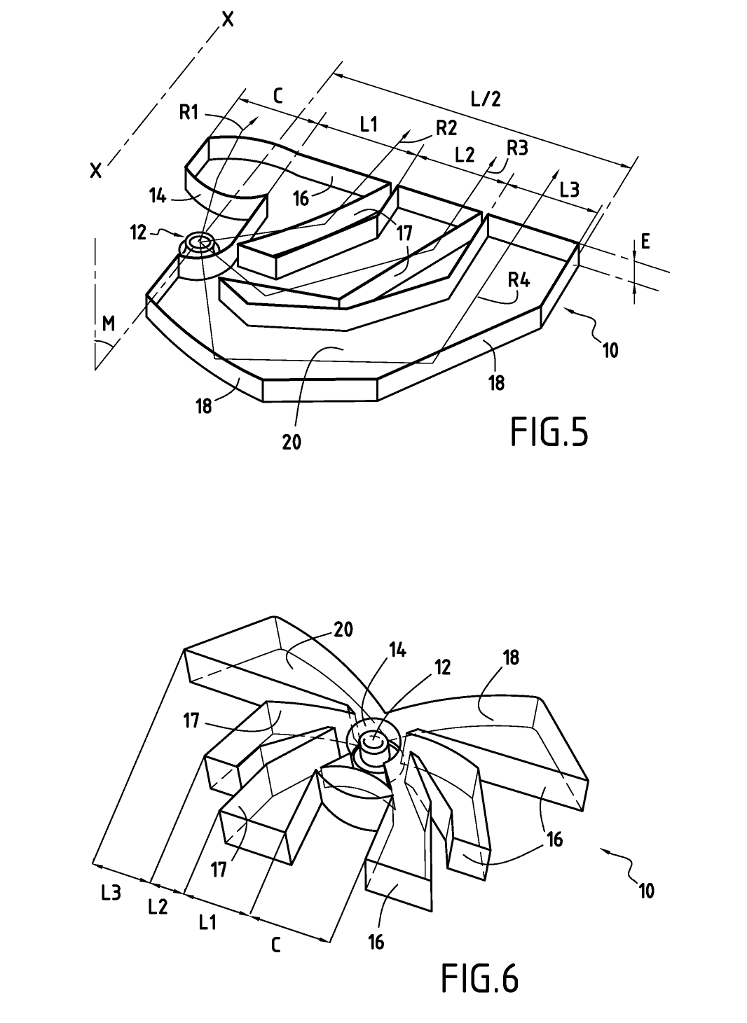

For reasons of clarity, FIG. 5 depicts only half of a light guide, produced in accordance with the present invention, and designated overall by the reference 10. The complete guide is formed by joining the half depicted and another half symmetrical with respect to a vertical mid-plane M, as variants of a guide have been depicted for example in FIGS. 6, 7, 8 and 11.

The guide 10 is associated with a light source 12, consisting of example of a light emitting diode. The light rays emitted by this source 12 enter the guide 10 through an entry face 14 and emerge therefrom by an exit face 16, their direction after the exit face 16 being substantially parallel to a general direction X-X oriented from rear to front.

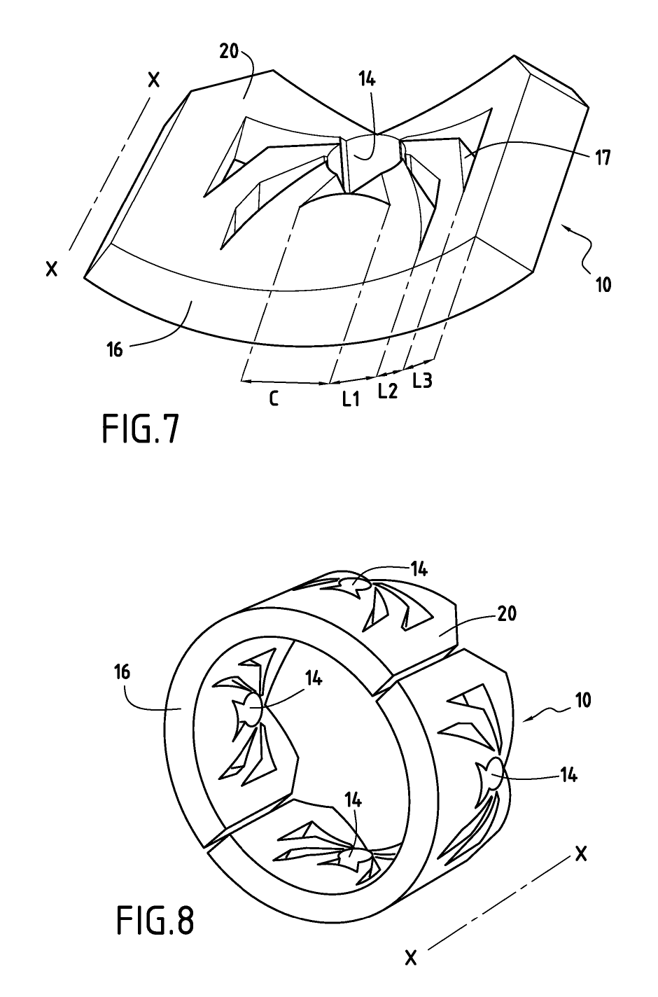

In accordance with the present invention, the guide 10 consists of a block 20 of transparent material whose thickness E is much smaller than its width L. By way of non-limiting example, the width L can be twenty times greater than the thickness E. The exit face 16 thus has the form of a very elongate rectangle. Such a guide can be produced from a thermoplastic material such as polycarbonate (PC), or polymethyl methacrylate (PMMA) or any other transparent material, for example glass. In the example embodiments depicted in FIGS. 5, 6 and 11, the thickness is counted in the vertical direction, so that the guide 10 has its top and bottom faces substantially horizontal. In the example embodiments depicted in FIGS. 7 and 8, the exit face 16 of the guide 10 has a curved shape, the thickness is counted in the radial direction and the width in the circumferential direction.

In one embodiment, entry face 14 of the block 20 completely surrounds the source 12 so that a majority of the light rays emitted by the source enter this block.

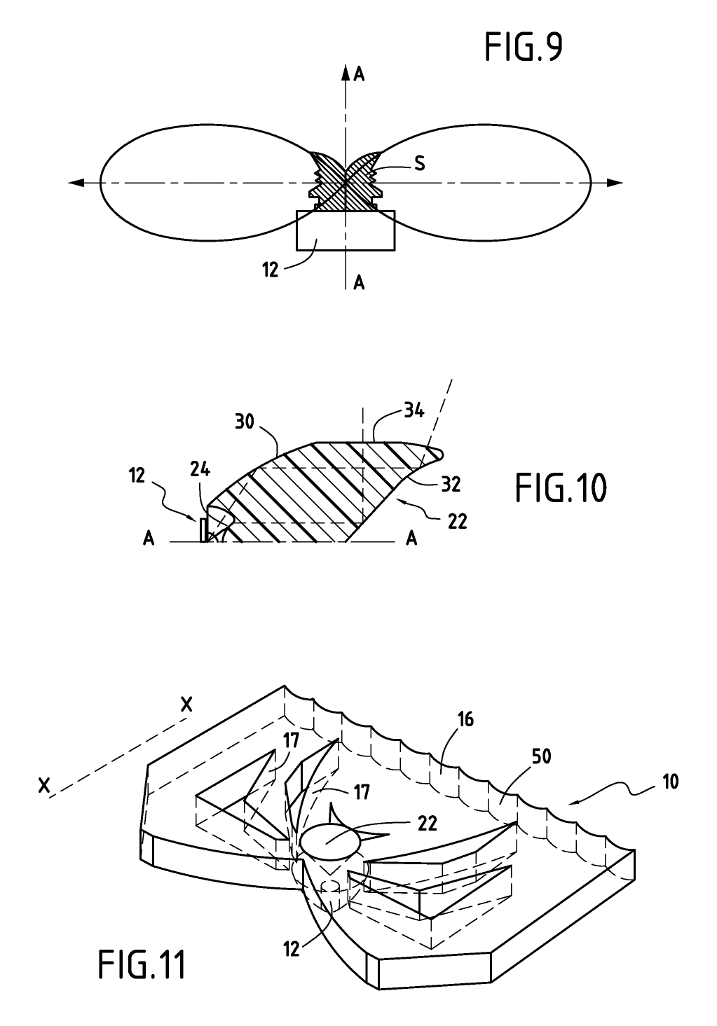

Advantageously, use will be made of a light source 12 having a radiation diagram like the one depicted in FIG. 9 and such that the light rays are emitted over 360° around the axis A-A of this source, situated in the mid-plane M, in an angle of approximately ±30° C with respect to the horizontal plane perpendicular to the optical axis A-A of the source. Such a light source 12 with light emitted diode is for example described in the document U.S. Pat. No. 6,679,621 and comprises a primary lens S procuring such a radiation diagram.

It is also possible to use a suitable optical system in association with a light emitting diode provided with a conventional primary lens, as depicted in FIG. 10. Such an optical system is similar to the light engine described for example in the document EP-A-1 416 220.

The light engine 22 depicted in FIG. 10 comprises an entry face 24 that is arranged axially opposite the diode 12. The profile of the entry face 24, in axial section, is such that the majority of the light rays emitted by the diode 12 enter the light engine 22.

The entry face 24 comprises a coaxial central portion forming a collimator that has a roughly hemispherical shape convex towards the rear, and a coaxial annular peripheral portion that has a roughly hemispherical shape concave towards the front.

The hemispherical profile of the central portion of the entry face 24 is such that the majority of the light rays received, coming from the diode 12, are refracted inside the light engine 22 whilst being diverted, so that these light rays enter the light engine 22 following a direction substantially parallel to the optical axis A-A.

The peripheral hemispherical portion of the entry face 24 is centred on the diode 12, so that the majority of the light rays received by the peripheral hemispherical portion, coming from the diode 12, are refracted inside the light engine 22 without being diverted.

The light engine 22 comprises a rear reflection face 20 with a concave parabolic annular shape. The rear reflection face 30 is designed to reflect axially towards the front, according to the principle of total reflection, the light rays that enter the light engine 22 through the peripheral portion of the entry face 24. To this end, the focus of the parabola forming the rear reflection face 30 is substantially merged with the light source 12.

The light engine 22 has a front reflection face 32 with a roughly convex and coaxial conical shape. The front reflection face 32 is designed so as to reflect, according to the principle of total reflection, the light rays travelling inside the light engine 22, towards a cylindrical exit face 34.

The front reflection face 32 comprises a conical central portion that is arranged axially opposite the entry face 24 and axially opposite a part of the rear reflection face 30.

The angle at the vertex of the conical portion is approximately 90°, so that the light rays that reach this conical portion and that are parallel to the optical axis A-A are reflected radially outwards.

The rays emitted by the source 12 thus strike the entry face 24 of the guide 12 at a predetermined angle of incidence, the entry face 24 making them undergo a refraction imposing a first deviation on them. The rays then propagate in the guide 10, able to undergo therein total reflections on the top and bottom faces of this guide.

Referring back to FIGS. 5-7, the guide 10 is divided into several sections by intermediate walls 17. The guide 10 thus comprises for example a central section C, situated in front of the light source 12, and in which the light rays such as RI undergo only a refraction on passing through the entry and exit faces 14 and 16, and possibly total reflections on the top and bottom faces of the central section C. The entry and exit faces 14 and 16 are configured so that the emerging light rays are substantially parallel to the general direction X-X. The exit face of the central section C can, as depicted in FIG. 5, be slightly convex. Any total reflections on the top and bottom faces do not modify the direction of propagation in the general plane of the guide.

The guide 10 also comprises lateral sections L₁, L₂ and L₃ in the examples depicted, the exit faces 16 of which are coplanar in the example in FIG. 5 and parallel in the example in FIG. 6, and perpendicular to the general direction X-X. The exit faces 16 can even be continuous or merged, as depicted in FIGS. 7, 8 and 11.

Each lateral section receives the light rays that have entered the guide 10 through the entry face 14, in the part of this section closest to the light source 12, and comprises at least one intermediate wall making the light rays undergo at least one total reflection, so as to make them emerge through the exit face 16, in a direction substantially parallel to the general direction X-X.

As can be seen in FIGS. 5 and 6, the first lateral section L₁ is delimited by a part of the entry 14, an exit face 16 and an intermediate wall 17 imposing a total reflection on the rays such as R₂ (FIG. 5), whilst the other sections L₂ and L₃ comprise two such intermediate walls 17, at least one of these intermediate walls interposing a total reflection on rays such as R₃ and R₄. The intermediate walls 17 separate the volume of the guide into distinct sections, each guiding part of the light flux emitted by the source 12 towards the exit faces 16.

The end lateral section, in this case the section L3, is delimited by part of the entry face 14, an exit face 16, an intermediate wall 17 and a lateral wall 18, imposing a total reflection on rays such as R4.

Through an appropriate choice of the angles made by the intermediate 17 or lateral faces 18 with the general direction X-X, the light rays can be distributed substantially uniformly on the exit faces 16. In the lateral sections as in the central section, any total reflections on the top and bottom faces do not modify the direction of propagation in the general plane of the guide.

It is thus possible to distribute all the light flux emitted by the light source 12 on the exit faces 16, using only the total reflection on the intermediate walls 17 of the guide 10, and possibly on the top and bottom walls, so that the illumination of the exit faces is even.

So as to perfect the evenness of the light beam emerging from the guide 10, or to confer a particular photometric pattern on it with regard to geometry, or even to confer a particular style on it, it will be possible to provide the exit face with optical arrangements 50, as depicted in FIG. 11.

Likewise it will be possible to confer on the exit face 16 a shape other than rectangular. As depicted in FIGS. 7 and 8, the guide 10 can be curved, so that its largest dimension, in this case its width L, is measured over an arc of a circle, and its smallest dimension, the thickness E, is measured radially.

It will then be possible to produce a guide 10 whose exit face 16 extends over a portion of a circumference, for example over approximately a quarter of a circle, as depicted in FIG. 7. It will thus be possible to join four guides 10 like the one depicted in FIG. 7 in order to obtain an assembly like the one depicted in FIG. 8, whose exit face 16 extends practically continuously in a full circle.

A lighting or signalling device has therefore indeed been produced that makes it possible to easily dispose a supplementary lighting and signalling function in a headlight. This is because the invention makes it possible to give the exit faces 16 a relatively small thickness E, for example less than 20 mm. The size of such a guide is therefore minimal, which enables it to be installed in a small volume.

Such a lighting or signalling device is also particularly simple to produce since it consists of a single piece, no adjustment being necessary. In addition the light beam obtained is extremely homogeneous, which makes it possible to easily obtain photometric performance meeting the regulations in force.

Naturally, the present invention is not limited to the embodiments described, but a person skilled in the art will on the contrary make many modifications to it which come within its scope. Thus the exit face can be disposed so that its largest dimension is vertical. Likewise the exit faces can have a shape other than planar, for example convex or concave.

While the forms of apparatus herein described constitute preferred embodiments of the invention, it is to be understood that this invention is not limited to these precise forms of apparatus, and that changes may be made therein without departing from the scope of the invention which is defined in the appended claims.

What is claimed is:

1. A lighting or signalling device for a motor vehicle, comprising a light source and a light guide associated with said light source, light rays issuing from said light source entering said light guide through an entry face and propagating in said light guide in order to emerge therefrom substantially parallel to a general direction of emission by an exit face, said light guide comprising at least one internal intermediate wall or a lateral wall on which a plurality of said light rays undergo at least one total reflection, wherein said light source is associated with an optical system such that said light rays are emitted over 360° around an axis of said light source, in an angle of approximately ±30° with respect to the horizontal plane perpendicular to the optical axis of said light source.

2. The lighting or signaling device according to claim 1, wherein the light guide has a central section and at least one lateral section separated by at least one internal or intermediate wall.

3. The lighting or signaling device according to claim 2, wherein a direction of the light rays emitted by the light source passing through said central section is modified only by refractions on the entry and exit faces.

4. The lighting or signaling device according to claim 3, wherein the direction of said light rays emitted by said light source passing through a lateral section is modified by at least one total reflection on at least one internal intermediate wall or one lateral wall.

5. The lighting or signaling device according to claim 1, wherein said light source consists of at least one light emitting diode.

6. The lighting or signaling device according to claim 1, wherein said light source is associated with a light engine having an entry face, a rear reflection face, a front reflection face and an exit face, the light engine emitting radially outwards the rays that it receives from the light source.

7. The lighting or signaling device according to claim 1, wherein the thickness of said light guide is small compared with its width.

8. The lighting or signaling device according to claim 7, wherein said exit face of said light guide has a shape of a very elongate rectangle.

9. The lighting or signaling device according to claim 8, wherein the exit face of said light guide extends over at least a portion of a circumference.

10. A vehicle light guide for use on a motor vehicle comprising:
a light guide body having an entry face for situating in operative relationship with a light source that is capable of emitting light rays and an exit face; and
at least one internal wall for causing a reflection of said light rays in a predetermined angle and in a generally horizontal plane relative to an axis of said light source.

11. The vehicle light guide as recited in claim 10 wherein said at least one internal wall comprises at least one first wall and at least one second wall, said at least one second wall causing at least a portion of said light rays to undergo a total reflection in said predetermined angle.

12. The vehicle light guide as recited in claim 10 wherein said predetermined angle is plus or minus thirty degrees with respect to a horizontal plane that is perpendicular to an optical axis of said light source.

13. The vehicle light guide as recited in claim 10 wherein said light guide body comprises a first section and a second section, said first and second sections being separated by said at least one internal wall.

14. The vehicle light guide as recited in claim 13 wherein said first section is a central section and said second section is a lateral section.

15. The vehicle light guide as recited in claim 13 wherein light rays passing through said first section is modified only by refractions on said entry face and said exit face.

16. The vehicle light guide as recited in claim 15 wherein light rays passing through said second section are modified by at least one total reflection off of said at least one internal wall.

17. The vehicle light guide as recited in claim 10 wherein said light source is a light emitting diode.

18. The vehicle light guide as recited in claim 10 wherein a thickness of said light guide body is smaller than its width.

19. The vehicle light guide as recited in claim 10 wherein said light guide body has a length at least twice as large as its width.

20. The vehicle light guide as recited in claim 10 wherein said exit face is continuous.

21. The vehicle light guide as recited in claim 10 wherein said exit face is interrupted.

22. The vehicle light guide as recited in claim 10 wherein said exit face defines a rectangle.

23. The vehicle light guide as recited in claim 10 wherein said exit face extends over at least a portion of a circumference.

24. The vehicle light guide as recited in claim 10 wherein said light source is a light emitting diode that emits said light rays in approximately 360 degrees about an axis of said light source, said light body capturing at least some of said light rays emitted over said 360 degrees and causing said captured light rays to be refracted or reflected such that they exit said light guide body through said exit face.

25. The vehicle light guide as recited in claim 24 wherein said exit face lies in an exit face plane that is generally parallel to said axis of said light source.

26. The vehicle light guide as recited in claim 25 wherein said exit face plane is curved.

27. The vehicle light guide as recited in claim 25 wherein said exit face plane is straight.
